(19) United States
(12) Patent Application Publication
(10) Pub. No.: US 2004/0251305 A1
(43) Pub. Date: Dec. 16, 2004

(54) Method and system for providing rebates

(76) Inventors: Tim Klapka, Tampa, FL (US); Marty O'Connor, Anaheim Hills, CA (US)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/497,852

(22) PCT Filed: Dec. 7, 2001
(86) PCT No.: PCT/US01/44702

(51) Int. Cl. G06K 15/00

(52) U.S. Cl. 235/383

(57) ABSTRACT

A method and system for distributing rebate forms at a point-of-sale (S204) of product. Information regarding rebate offers is kept in a database (S206), and retrieved at the time of a sale (S226) for use in printing a rebate form (S232) for the product. Rebate forms for more than one product may be printed on the same form.

### BACKGROUND OF THE INVENTION

### FIELD OF THE INVENTION

The invention relates to systems and methods for point-of-sale transactions in retail stores. More specifically, the present invention is directed towards systems and methods for providing a rebate form to the consumer at the point-of-sale for one or more rebate programs.

### DISCUSSION OF THE BACKGROUND

Rebate forms have long been used in the retail industry in order to influence the sale of packaged goods. Conventional rebate programs use preprinted rebate forms which are mass-produced and shipped to the various retail outlets. Typically, the rebate forms are shipped directly from the manufacturer or distributer to various stores which sell their products. Rebate forms are often bundled together on tear-away pads which are intended to be posted within the retail store. For example, there is often a rebate form bulletin board located at the front of the store, or in another central location, which may be accessed by customers. The store personnel or clerks are generally called upon to post the various rebate form tear-away pads received from manufacturers.

Manufacturers may also rely upon magazine advertisements to inform consumers about conventional rebate programs. Another avenue for distributing rebate forms is through the use of mass mailing campaigns. In each of these conventional methods, manufacturers attempt to deliver the rebate forms to a target audience by using magazines which have readers with demographics favorable to the manufacturer. Similarly, consumer databases may be used for mass mailings in order to attempt to reach consumers with certain demographic characteristics.

Rebate programs have traditionally been intended to entice price conscious consumers to purchase the rebate offerors' product instead of the products of competitors. In this way, the company promoting their product through a rebate program can gain valuable market share away from competitors. However, conventional rebate programs are subject to a number of drawbacks. First, for a rebate program to be effective, the customer must become aware of the rebate offer, and then be influenced by it to purchase the product. Even if the customer is aware of the rebate offer, conventional methods of distributing rebate forms require a fair amount of effort on the consumer's part. When the rebate forms are distributed using bulletin board tear-away pads, the customer must make an effort to find the store's bulletin board and seek out the rebate forms, if any are available. For advertisements and targeted mailings, once the customer discovers the rebate form, the customer must save it until the product has been purchased and a receipt and proof-of-purchase are available.

The rebate bulletin boards are often haphazardly organized, making it difficult for consumers to find rebate forms for the products they are interested in. In addition, the tear-away rebate form booklets are sometimes lost, or depleted before the rebate program ends. Rebate programs which rely on mass mailing or advertisements in periodicals can be subject to uncertainty as to the number of rebate forms which will be redeemed. That is, it is difficult to estimate and control the number of rebate forms which will be submitted to a manufacturer.

After a product has been purchased for which a rebate is available, conventional rebate methods require that the customer clip the proof-of-purchase symbol from the product. The customer then mails the proof-of-purchase, along with the cash register receipt and the filled-out rebate form, to the manufacturer of the rebate product.

In addition to these drawbacks, conventional rebate programs may be subject to fraud. For example, rebate forms can be submitted by non-purchasers using a proof-of-purchase retrieved from the trash or otherwise obtained, along with a sales receipt of a comparably priced product. Since the format and information provided on sales receipts varies from one store to another, it is often difficult to positively identify a rebate product based on sales receipt information.

For these and other reasons recognized by the present inventors, an improved system of providing rebate forms is desired.

### SUMMARY OF THE INVENTION

The present invention overcomes the aforementioned drawbacks of conventional rebate programs, and provides benefits not heretofore realized in the prior art. Use of the present invention reduces the possibility of fraud, since the rebate form is printed on the same piece of paper as a proof-of-purchase. In addition, targeted advertising is more easily and effectively achieved in accordance with the present invention. Rebate programs according to the present invention can be advertised directly on the product label or on the pricing signage located on the product shelving.

One embodiment of the present invention involves methods and systems for distributing rebate forms, in which a product identification code is detected at a point-of-sale. Based upon the identification code, a rebate program database is accessed, and it is determined whether there is a rebate program associated with the product. A rebate form is printed out at the point-of-sale for any rebate program associated with the product, with the rebate form serving as a proof-of-purchase for the product.

Another embodiment of the present invention involves methods and systems for providing rebate forms at a point-of-sale which is achieved by establishing a communication link between a retail store information system and a rebate clearinghouse. Information about the rebate program for various products is stored in a database at the retail store. The information system of the retail store is configured to print rebate forms for said rebate program in response to purchases of the product. The rebate forms contain information provided by the information system. Upon making a sale of a rebate product, information of the purchase is communicated via the communications link from the retail store to the clearinghouse.

Another embodiment of the present invention involves methods and systems for providing a rebate to a customer. Rebate information is determined at appoint-of-sale for a rebate product, and the rebate form is printed out at the point-of-sale. Upon receiving the rebate form at a clearinghouse from the customer, the form is machine read, and the rebate is then sent to the customer.

It will appreciated from the foregoing that the present invention represents novel advances in the field of rebate programs in the retail store sector. In particular, the present invention provides for centralized control of a rebate program, rebate advertising directly at the product location on the shelf, and point-of-sale delivery of rebate forms. Other aspects and advantages of the invention will become apparent from the following more detailed description, taken in conjunction with the drawings.

These and other aspects of the invention will now be described in greater detail in connection with the number of exemplary embodiments.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a block diagram of an in-store system for implementing the present invention;

FIG. 2 is a flow chart for implementing the present invention in retail stores; and

FIG. 3 is a flow chart depicting an implementation of the present invention amongst a number of retail stores.

### DESCRIPTION OF THE PREFERRED EMBODIMENTS

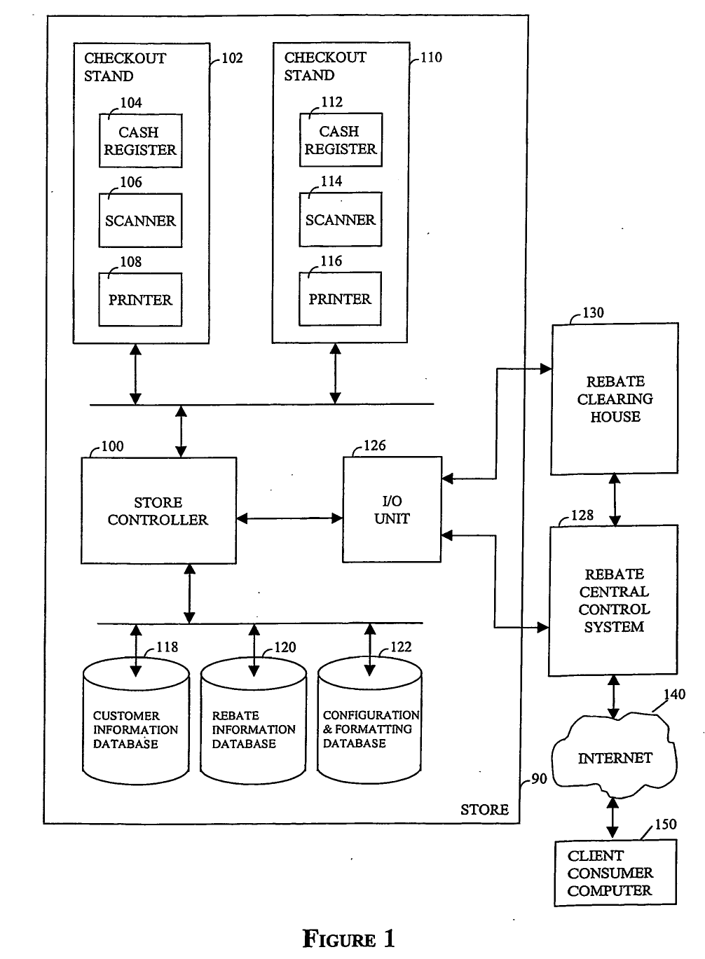

FIG. 1 depicts a retail store configuration for implementing the present invention. The system depicted in FIG. 1 represents a system for implementing a rebate program, and for gathering information concerning the sale of rebate trigger items. By definition rebate trigger items are the products which are the subject of a rebate program, that is, products for which a rebate is being offered. The system of FIG. 1 includes a store controller 100, a plurality of checkout stands 102 and 110, a customer information database 118, a rebate information database 120, a configuration and formatting database 122, and an input/output unit 126 configured within store 90. Each of the checkout stands (which may be called cash register stations) has a cash register, a scanner and a printer. For example, checkout stand 102 includes cash register 104, scanner 106 and printer 108. The input/output device 126 is in communication with a rebate central control system 128, which may be in communication with other stores as well. The configuration depicted in FIG. 1 for store 90 is a typical configuration of the present invention. However, variations of this configuration and other configurations for communicating point-of-sale information within a store may be used with the present invention as well. FIG. 1 also depicts a clearinghouse 130 which serves to receive, process and redeem the filled-out rebate forms. In some embodiments, the rebate central control system 128 serves as the clearinghouse 130, that is, the rebate central control system 128 and the clearinghouse 130 are part of the same organization or company. In other embodiments, the role of the clearinghouse 130 is served by the manufacturer of the rebate product, the manufacturer's agent, or another entity sponsoring the rebate program (e.g., a distributor, wholesaler or retailer of the product).

The store controller 100 can be embodied as a computer, processor, or other type of controller device or logic. The store controller 100 is typically located in an office area within the store, but may be located off-site and configured for remote control of the various checkout stands or cash register stations. The store controller 100 is in communication with the checkout stands throughout the store. The various components of the information system for the store 90 depicted in FIG. 1 are interconnected by a bus 124. The bus 124 may consist of either hardwired interconnections, wireless interconnections, or a combination of both.

Retail stores typically have one or more checkout stands, such as the checkout stands 102 and 110 shown in FIG. 1. The checkout stand 102 represents a typical configuration, comprising a cash register 104, a scanner 106 and a printer 108. In some embodiments, the cash register 104 has a computer or a processor integrated locally within the device. In other embodiments the cash register 104 is a dumb terminal which is centrally controlled, or alternatively, a portion of the distributed logic spread through the store 90. In the embodiment depicted, the cash register 104 controls scanner 106 and printer 108. In other embodiments the scanner 106 and printer 108 are controlled centrally by the store controller 100, which is either located on site as shown or remotely located.

The scanner 106 generally consists of a bar code scanner, as is known in the art. Other types of data entry devices can be used in accordance with the present invention. For example, the universal product code (UPC) of the product or other identifying mark, can be manually entered, or can be entered via character recognition, magnetic codes, or other like product marking schemes. The printer 108 can either be integrated as part of the cash register 104, or can be a stand-alone unit conveniently located for access by the customer. The printer 108 used in accordance with the present invention, can be the same printer used for printing sales receipts, or can be a stand-alone printer dedicated to the printing of rebate forms and/or coupons. The checkout stands 102 and 110 can contain all of the aforementioned devices integrated into one package, or may comprise modular versions of the cash register 104, the scanner 106 and printer 108 suitably located for the convenience of the checkout clerks and customers.

The configuration of retail store 90 depicted in FIG. 1 also includes a customer information database 118, a rebate information database 120 and a configuration and formatting database 122. These databases can be contained within the memory of a computer serving as the store controller 100, or can be contained within other interconnected storage devices, located on-site or remotely, which can be accessed by the store controller 100. The three databases 118, 120 and 122 can be separately maintained databases, or alternatively, can be different portions of a single integrated database. In an alternative embodiment, information of one or more of the databases 118, 120 and 122 can be encoded on a label which is affixed to the product. In general, the customer information database 118 contains information about particular trigger item purchases or customers, the rebate information database 120 contains information about the rebate programs being offered, and the configuration and formatting database 122 contains information for operating or communicating with the equipment in the store 90.

The customer information database 118 contains information concerning purchases of rebate trigger items consummated at the store 90, and information about registered customers of the store 90. The customer information database 118 contains the name and address, and possibly the telephone number, of the customer. Other identifying information may be included in the customer information database 118, as well as information about that customer's buying trends, preferences, and participation in other incentive programs. Such information is often considered valuable for use in the marketing endeavors of retail stores. The customer information database 118 can be a dedicated database specifically for use with a rebate program, or can be used in conjunction with the store 90's own stored customer information. For example, a chain of grocery stores may offer special incentives or target information for preferred customers registered with the grocery store chain. The store typically keeps customer information pertaining to its preferred customer program in some sort of computer database or other type of accessible storage. Generally, a preferred customer offers a card (or other ID) at the checkout which has a membership identification number used to access the store's preferred customer information. In some embodiments of the present invention, the store's preferred customer information can be integrated with the customer information database 118.

The customer information database 118 also contains information about the sales of rebate trigger items at a particular retail store, e.g., store 90. The trigger item sales information generally includes the date and purchase amount of the sale, and can also include more detailed information such as the time of day of the purchase, and other products which the customer purchased at the same time. The trigger item sales information can be linked to the available customer information, if any. The customer information can be in the form of an identification code for a registered customer, or a pointer to the registered customer's account identifying that customer as the purchaser.

Some embodiments of the invention include purchase verification data for the sale of each rebate trigger item. Such verification information is sent to the rebate clearinghouse or manufacturer as an added measure of security to avoid fraud. The purchase verification data may include a rebate form code specific to a particular purchase to serve as a confirmation of that purchase. In such embodiments, the rebate is only provided for those rebate forms which include the correct verification data. Alternatively, the verification information can be encoded in the rebate form itself in the form of specialized codes, marks or designs printed on the form. The information about such codes markings or designs can be contained within any of the databases 118, 120 or 122, but preferably within the customer information database 118.

The rebate information database 120 contains information specific to various rebate programs being offered for products sold in the store 90. The rebate information includes the amount of the rebate, product UPC codes to which the rebate applies, the beginning date and expiration date for the rebate program, and any other applicable rules or limitations for the rebate program. In addition, the address, telephone number, and web site address of the manufacturer offering the rebate is included within the rebate information database 120. The rebate information database 120 can also be used to store information intended for the manager of store 90 for use in running or managing the rebate programs. The rebate information database 120 can also include advertising information for various rebate programs, e.g., information to be printed on the labels or price tags of the product, or signs to be displayed on the shelf where the product is located. In an alternative embodiment, data of the rebate information databases 120 pertaining to a particular product can be encoded on a label which is affixed to that product. In this way, when the product is scanned or otherwise detected at the checkout stand, the rebate information data is communicated to the checkout stand printer for printing out a rebate form.

The configuration and formatting database 122 contains information for operating the equipment of the store 90 such as the store's cash registers, computers, scanners, or inventory system. The database 122 also contains information for communicating with the store 90 or with equipment of the store. For example, the configuration and formatting database 122 contains communication protocol information specific to the store 90 equipment, and information necessary for formatting and printing a rebate form at the point-of-sale using the printers of store 90, e.g., printers 108 and 116. The configuration and formatting database 122 also contains information for the fonts and formats required by the various printers within the store, such as the printer 108 and printer 116 of FIG. 1. Basically, the database 122 is intended for storing any information which is specific to the equipment in store 90 or is necessary for communications between store 90 and the rebate central control system 128. Hence, the information contained within the database 122 is preferably selected for, or customized for, the particular equipment configurations of the store 90. By contrast, the information concerning various rebate programs contained in the rebate information database 120 is generally consistent from one store to the next, since the information in database 120 concerns rebate programs which may be implemented in large numbers of stores across the region.

The store controller 100 communicates with a rebate central control system 128 to receive information pertaining to various rebate programs and the instructions for implementing these programs. The store controller 100 can also send information concerning the sales of rebate trigger items. As shown in FIG. 1, the store controller 100 can communicate with control system 128 via an input/output unit 126. The input/output unit 126 can be a computer modem, an Internet port, a satellite dish antenna, or any other like communication device. In alternative embodiments, the store controller 100 may communicate with the rebate central control system 128 by exchanging computer disks or other portable storage media containing information. Communication may also be implemented via email. In practice, it tends to be most convenient to set up the initial system using computer disks to download information to the store controller 100, and then communicate updates and subsequent information concerning rebate programs via the Internet, email, or an other communication link.

In one embodiment, the store controller 100 communicates with the rebate central control system 128 both for receiving rebate program information and for sending information of the rebate trigger item sales (e.g., trigger item sales transaction data and verification symbols). In this embodiment, the rebate central control system 128, which implements the rebate programs, also serves as the rebate clearinghouse 130 to process the redeemed rebate forms. In other embodiments, the information concerning rebate trigger item sales can be communicated directly to the manufacturer, or an agent of the manufacturer. In such embodiments, the rebate central control system 128 implements the rebate programs, while the manufacturer or its agent serves as the rebate clearinghouse 130 to process the redeemed rebate forms. In yet other embodiments, some rebate programs are implemented with the rebate central control system 128 serving as the rebate clearinghouse 130 while other rebate programs are implemented with the manufacturer or an agent serving as the rebate clearinghouse 130.

In yet other embodiments, rebate central control system 128 and consumer computer 150 contain means to connect internet 140. In addition, rebate central control system 128 may communicate the rebate offer to the stores customer via the customer's consumer computer 150. One means for accomplishing this is for rebate central control system 128, or another computer system in communication with rebate central control system 128 to run web server software and to make an electronic version of the rebate form available for downloading by the stores customer to consumer computer 150. For example, rebate central control system 128 may run web server software establishing a “personal page” for the customer. Personal pages and websites providing personal pages and other consumer purchase history based incentives are disclosed in U.S. Pat. No. 6,014,634 the entire contents of which are hereby incorporated by reference. Briefly, however, a consumer's personal page or personal page is a web page presenting the consumer data contained in a personal database containing information for the individual consumer. A login may be associated with the personal web page and IP address may be associated with the personal web page. A cookie on the consumer's computer may be associated with the personal web page. In this alternative embodiment, the rebate form is provided to the consumer via the consumer's personal web page from which the consumer can download the rebate form. A benefit of this embodiment is that it avoids the stores costs associated with printing the rebate form. Another benefit of this embodiment is that it allows the consumer to determine when to receive the rebate form. In a related embodiment, the rebate central control system 128 may email the rebate form to an email address associated with the customer. With both the personal page embodiment and the email embodiment, the timing of making the rebate form available on the customer's personal page or the emailing of the rebate form to the consumer may be specified. For example, the personal web page may make the rebate form available only for the period of time ending near the end of the date upto which the rebate is valid. For example, the day of, the day before, or the week before the rebate offer expires the form may be made available. Moreover, the email embodiment may include timing such that the email is transmitted to the consumer after a period of time from when the consumer purchased in the store. For example, the period of time may be equal to or slightly less than (e.g., one day, two days, or one week prior to) an expected period of delay between the consumer's shopping visits or a product purchase cycle time period.

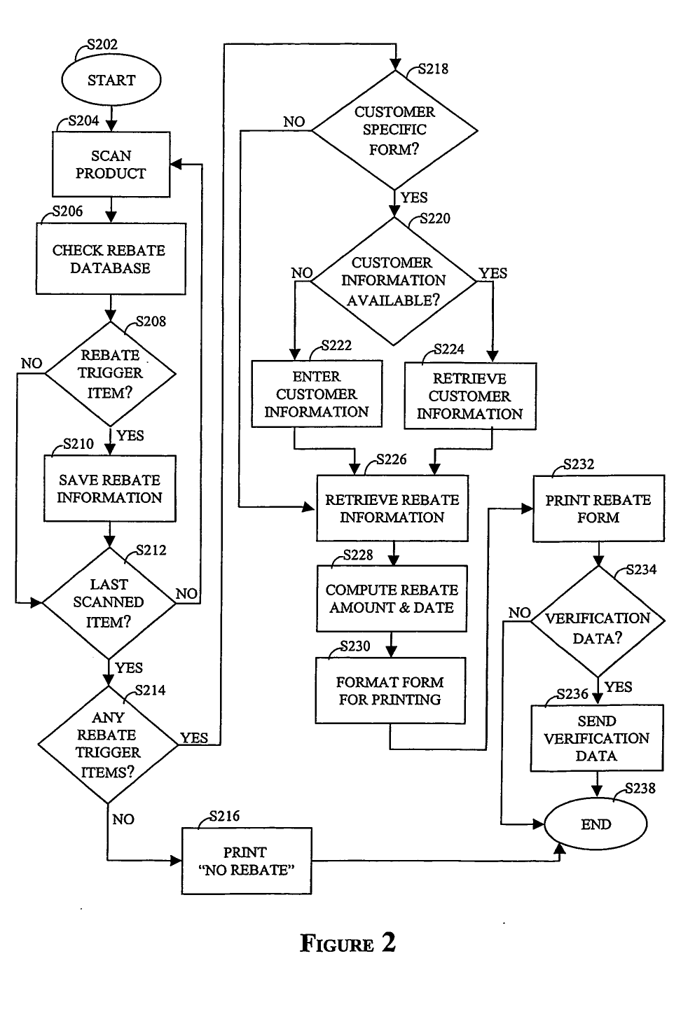

FIG. 2 depicts a method in accordance with the present invention. The method begins at step S202 and proceeds to step S204 where a product is scanned at the point-of-sale, e.g., at scanner 106 of checkout stand 102. Step S204 may entail scanning a product's UPC code using a bar code reader or other like system for entering product identification. Alternatively, step S204 can be performed by manually entering the product identification information. Once the UPC code has been scanned or the product identification information has otherwise been entered in step S204, the method proceeds to step S206.

In step S206, it is determined whether a rebate program exists for the product being purchased. This may be done by examining a database containing rebate information, e.g., database 120 of FIG. 1. In addition, the rebate information database is consulted for the presently scanned product in combination with previously scanned products, for which a special combination rebate program is being offered. That is, a rebate program which applies when a predefined combination of products is purchased at one time in a store. In an alternative embodiment a combination rebate program can be offered for the purchase of a combination of products, or a certain number of the same product, which are purchased over a predefined period of time at a particular store or at associated stores.

Upon completing step S206, the method proceeds to step S208 for determining whether the product is a rebate trigger item, i.e., a rebate program is offered for the purchased product. In some embodiments, the product may have a rebate program associated with it, but not be a rebate trigger item. For example, a rebate program may apply only to preferred customers of the store who purchase a particular product. Hence, another customer (i.e., not a preferred customer) purchasing the product would not be eligible for a rebate since the product is not a rebate trigger item for that (non-preferred) customer. In step S208, if the product is a rebate trigger item, then the method proceeds from step S208 in accordance with the “yes” branch to step S210 where the rebate information retrieved in step S206 is saved or otherwise tagged for use in processing the customer's rebate form. Upon completing step S210, the method proceeds to step S212. Back in step S208, if it is determined that the scanned product is not a rebate trigger item, the method proceeds in accordance with the “no” branch to step S212.

In step S212 it is determined whether the scanned product is the last product being purchased by the customer. If the scanned product is not the last product and there are further products to be scanned, then the method loops back to back to step S204 in accordance with the “no” branch from S212, in order to scan the next product. If, in step S212, it is determined that the scanned product is the last product being purchased at that time, then the method proceeds from step S212 in accordance with the “yes” branch to step S214. In step S214 it is determined whether any rebate trigger items are being purchased by the customer. If no rebate trigger items are being purchased, then the method proceeds in accordance with the “no” branch to step S216 to print a message on the receipt stating that no rebates are offered for the items being purchased. The method then proceeds to step S238, and ends. In an alternative embodiment, the method can proceed directly from step S214 in accordance with the “no” branch to step S238, with no provision being made to print a message on the receipt if there are no rebate trigger items being purchased. If, in step S214, it is determined that the purchase includes one or more rebate trigger items, then the method proceeds in accordance with the “yes” branch from step S214 to step S218.

In step S218 it is determined whether the rebate form is to be in a format which is customer specific (e.g., containing the customer's name and mailing address information preprinted on the form), or simply a generic form with blanks for the customer to enter their own name and address. Some manufacturers may prefer to have customer specific rebate forms preprinted so as to simplify or reduce the amount of data entry at the receiving end. Other manufacturers may prefer to have generic forms with blanks for the customer to enter their own name and address information. Providing a generic rebate form may produce lower rebate redemption rates than the use of customer specific rebate forms with preprinted customer information. If in step S218 it is determined that a generic rather than a customer specific rebate form is to be used, the method proceeds in accordance with the “no” branch from step S218 to step S226. However, if in step S218 it is determined that a customer specific rebate form is to be used for the current rebate transaction, the method proceeds in accordance with the “yes” branch from step S218 to step S220.

In step S220 it is determined whether the necessary client information is kept within a customer information database 118, or other such information storage facility. If the customer information is available, then the method proceeds in accordance with the “yes” branch from step S220 to step S224 where the customer information is retrieved from the customer information database 118 shown in FIG. 1. Upon retrieving the information, the method proceeds from step S224 to S226. However, if in step S220 it is determined that the customer information is not available in any database, or is insufficient, the method proceeds in accordance with the “no” branch from step S220 to step S222. In step S222 the checkout teller is prompted to request the customer information for manual entry. Alternatively, in step S222 the customer may be provided with a data entry terminal for entering the necessary customer information for the rebate form. The data entry terminal can be a keyboard, a speech recognition device, or other like data entry system. The data entry terminal for use by the customer could be conveniently located past the checkout stand so as not to hold up the point-of-sale transactions of other customers. Upon entering the customer information in step S222, the method proceeds to step S226.

In step S226, all the rebate information pertaining to the applicable rebate trigger item(s) being purchased is gathered (e.g. retrieved from the rebate information database 120 shown in FIG. 1, or from a like storage facility). Once the rebate information has been retrieved, the method proceeds to step S228 for compilation of the rebate form parameters such as the total rebate amount, expiration data, and applicable rules concerning the rebate.

In accordance with one embodiment of the present invention, the amounts of all rebates for the products being purchased at the point-of-sale by the customer are compiled into one master amount for printing on a single master rebate form. A master rebate form is convenient for the customer in that only one form needs to be mailed in in order to collect the cumulative rebate amounts for the various rebate trigger items being purchased. An additional aspect of this embodiment is that one centralized rebate clearinghouse can collect the master rebate form for various rebate programs, and then distribute a single master rebate amount to the customer. In alternative embodiments, instead of having a single master rebate form, multiple rebate forms can be printed on the same strip of paper. One or more of the multiple rebate forms can itself be a master rebate form for a plurality of rebate products.

In some situations various rebate trigger items being purchased have rebate offers with different expiration dates. In one embodiment for such situations, a predetermined default expiration date is determined. This can be done by using either the earliest-in-time expiration date, using the latest-in time-expiration date, or any other convenient date, e.g., any date which is agreeable to the various manufacturers offering the rebate programs. One such convenient date for use as an expiration date is a date which is transaction-date dependent. For example, it can be prenegotiated with all participating manufacturers that the rebate forms will be valid for redemption for a predefined time (e.g., three months) from the date of purchase. The use of a transaction-date dependent expiration date avoids having rebate programs with incongruent or conflicting terms regarding their respective expiration dates.

In another embodiment, the master rebate form can be used with the various rebate amounts and their corresponding expiration dates printed on the master rebate form, preferably in chronological order showing the amount that the master rebate will be in relation to the various expiration dates. In another embodiment of the invention, the various rebate forms which have differing expiration dates (or other conflicting terms, e.g., redemption address) are all printed separately, or on the same strip of paper so they can easily be separated. In this way, the customer can redeem all the rebate forms at once or can redeem them separately depending on the customer's preference or situation (e.g., different family members are entitled to various rebate amounts for the different rebate trigger items). In yet other embodiments, multiple related rebate trigger items can be compiled onto a single rebate form, while other unrelated rebate trigger items, or items with conflicting rebate terms and conditions, can have a stand-alone rebate form.

Upon completing step S228, the method proceeds to step S230. In step S230 the rebate form, or multiple rebate forms, are formatted for printing. Such formatting can include provisions for providing verification data on the rebate form itself. In accordance with the present invention, the rebate form serves as a proof-of-purchase as well as a means of conveying the terms and conditions of the rebate (e.g., dollar amount and expiration date), and, in some embodiments, customer specific information (e.g., the customer's address). In this way, the present invention is advantageous over convention methods since the customer is not required to separately provide a rebate form, along with a proof-of-purchase consisting of the product's UPC code and retail store receipt. The use of a rebate form according to the present invention which serves as a proof-of-purchase also reduces the amount of data entry and processing at the rebate redemption center (e.g., rebate redemption clearinghouse or the manufacturer). Hence, the present invention simplifies the rebate process for the customer, and also streamlines the rebate process for the rebate clearinghouse or manufacturer.

The information to be formatted for printing on the rebate form includes the applicable terms, conditions, and rules of the rebate offer, as well as the amounts pertaining to the rebate offer and the expiration date. The rebate form also includes the mailing address information for the rebate clearinghouse or manufacturer to which the rebate form.

Alternative embodiments do not require that the customer mail the rebate form to receive rebate compensation. In these embodiments, the rebate form can be redeemed for a store credit. Such a store credit may be applied towards the purchase of any type of goods carried by the store, or for a predefined type of good (e.g., one or more products of the rebate item manufacturer). In another alternative embodiment, the rebate form can either be mailed in for a rebate amount or alternatively be cashed in for a store credit, at the option of the customer. In such embodiments, the rebate amount may differ from the store credit amount, and the store credit amount may be different for different products.

Upon completing step S230, the method proceeds to step S232 for printing the rebate form. In one embodiment, the rebate form can be formatted for printing on the same strip of paper as the cash register receipt. In alternative embodiments, a different printer can be provided for printing a rebate form separately. In such instances, the rebate form can be printed in the format of a postcard, with or without prepaid postage or a postage guarantee.

Upon performing step S232, the method proceeds to step S234 where it is determined whether verification code is to be sent to the rebate clearinghouse or manufacturer, in a communication separate from the rebate form. The verification code may include a rebate form number containing many digits or alpha numeric characters, or other like type of verification symbol. The verification code can be in a format which is not readily discernable, e.g., magnetically encoded, in bar code format, or in the form of a border design or logo variation. The verification code may be transaction-specific (i.e., each specific transaction has its own identifiable verification code to confirm that specific purchase) or can be common for like purchases (e.g., each chain of stores has its own verification code to confirm a purchase at that chain of stores, or each type of rebate product has its own verification code to confirm a purchase of that type of product). In embodiments including a provision for verification, the clearinghouse only pays out the rebate amount for those rebate forms which include the correct verification code. If, in step S234, it is determined that there is not a verification code associated with the rebate target item, then the method proceeds via the “no” path to step S238, and ends. If the rebate target item does have a verification code associated with it, then the method proceeds to step S236 via the “yes” path. In step S236 the rebate verification code is communicated to the rebate clearinghouse. This may be achieved by sending the rebate verification codes via email, uploading it to a website, sending by modem, sending paper copies, or other like mode of communication. The verification codes may be send individually as they are generated, or may be stored and sent periodically, e.g., at the end of the day. Upon communicating the verification code to the rebate clearinghouse in step S236, the method proceeds to step S238 where it ends.

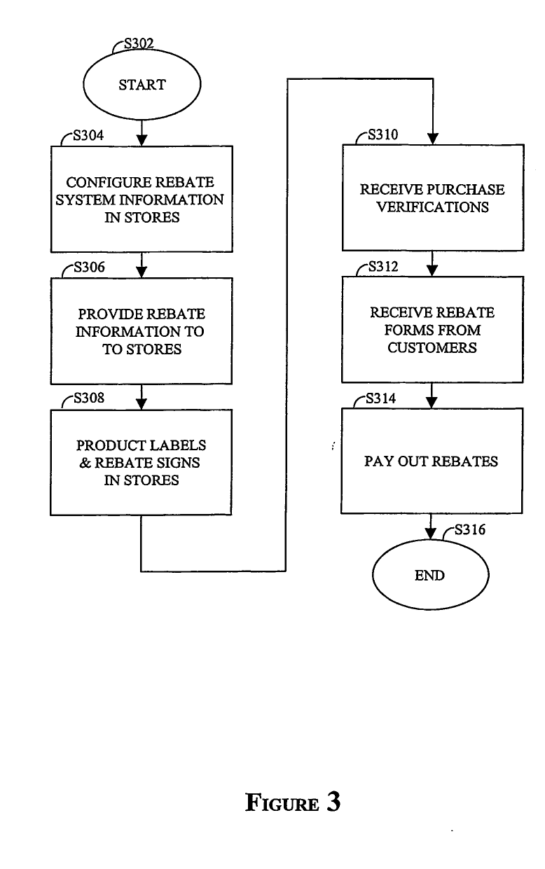

FIG. 3 depicts a method for carrying out the present invention from the perspective of the rebate central control system 128 shown in FIG. 1. The method starts in step S302 and proceeds to step S304 where individual stores (e.g., store 90) have their computer systems, databases, communication systems and other equipment configured to store, process and communicate information for carrying out the present invention. This typically involves the establishment of communication links, and computer programs being downloaded from the central system 128 to the store 90. Step S304 typically involves the storage of an initial set of data in one or more databases. For example, this may entail storing customer information in the database 118, storing rebate information in the database 120 and storing equipment formatting and configuration information in the database 122, as shown in FIG. 1. In addition, one or more computer programs, routines, or other such logic, can be loaded into the store controller 100. Similarly, step S304 may entail configuring the input/output unit 126 for facilitating communication between the store controller 100 and rebate central control system 128. Step S304 generally covers the considerations of initializing one or more stores for practicing the present invention. However, some aspects of step S304 may need to be repeated, or updated, due to changes in the equipment or systems in the stores or in the central facility. Once the configuration has properly been achieved in step S304, the method proceeds to step S306.

In step S306, rebate information about particular rebate programs is downloaded into the rebate information database 120. Step S306 is an ongoing process which is performed as new rebate programs are implemented. For each new rebate program being implemented the information is downloaded into the appropriate database within each of the participating stores, e.g., the store 90. Following step S306 the method proceeds to step S308.

Step S308 involves setting up signs or labeling in the proximity of the product shelves to communicate particular rebate programs to potential customers. This may entail labeling products with price tags or stickers containing an indication that a rebate offer exits. Step S308 may also entail setting up displays, placards or signs to be affixed to the shelves or in the general proximity of the products to indicate the existence of a rebate offer. Such information can also be affixed to the rebate offer bulletin board typically located in the front of the store. In practice, the actual labeling of products or positioning of signs of step S308 may be performed by the personnel of the store 90 (e.g., stock clerks), rather than the personnel of the rebate central control system 128. Upon completing step S308, the method proceeds to step S310.

Step S310 involves the receipt of verification codes. As discussed above in conjunction with step S234 of FIG. 2, some embodiments of the present invention entail the exchange of rebate trigger item verification codes. In accordance with these embodiments, upon the purchase of a trigger item a verification code is sent from the store 90 to the rebate clearinghouse 130. Then, when the system 128 receives a rebate form from the customer, a verification code associated with the rebate form is checked against the stored verification code number received from the store 90. In this way, fraudulent rebate transactions can be avoided. Once the rebate form has been verified, the method proceeds to step S312. Alternatively, in embodiments with no provision for the use of verification codes, the verification process may simply entail a visual examination of the rebate form upon receiving it from the customer to ensure it is not a forgery. The method proceeds from step S310 to step S312.

In step S312, the rebate clearinghouse 130 receives the completed rebate from the customer. Generally, the customer sends the rebate form through the mail, although any form of delivering the rebate form to the rebate clearinghouse 130 is acceptable. Once the rebate clearinghouse 130 has received the rebate form in step S312, the method proceeds to step S314 for payment of the rebate amount. If the verification codes match, a rebate amount is mailed or otherwise credited to the customer. Upon payment to the customer of the rebate amount in step S314 and, the method proceeds to step S316 and ends.

To facilitate an understanding of the invention, many aspects of the invention have been described herein in terms of sequences of actions to be performed by elements of a computer system. It will be recognized that in each of these embodiments, the various actions could be performed by specialized circuits (e.g., discrete logic gates interconnected to perform a specialized function), by program instructions being executed by one or more processors or other such processing devices, or by a combination of these. Moreover, the invention can be embodied entirely within any form of computer readable storage medium having stored thereon an appropriate set of computer instructions that would cause a processing device to carry out the method described herein. Thus, the various aspects of the present invention can be embodied in many different forms, and all such forms are contemplated to be within the scope of the invention.

For the sake of illustrative simplicity, the invention has been discussed in terms of systems and methods involving rebate trigger items. While the term “items” is generally thought to apply to tangible products, the present invention applies more broadly to services as well as goods. That is, the present invention also applies generally to rebate trigger purchases which may either be goods, services or a combination of both. For example, the present invention could be used in conjunction with the purchase of a telephone calling card which is associated with a predefined amount. While a telephone card is a tangible product, the service offered in the form of completing a telephone call and the services of human telephone operators is also associated with such a phone card. A telephone calling card is but one of example of the many product/services which may be used in conjunction with the present invention. In those instances when a pure service or a service/product is involved, the company offering the rebate is often referred to as a service provider rather than a manufacturer.

It will be appreciated by those skilled in the art that the present invention can be embodied in other specific forms without departing from the essential aspects or characteristics thereof The presently disclosed embodiments are therefore considered in all respects to be illustrative and not restrictive. The scope of the invention is indicated by the appended claims rather than the foregoing description, and all changes that come within the meaning and range of equivalents thereof are intended to be embraced therein.

Obviously, numerous modifications and variations of the present invention are possible in light of the above teachings. It is therefore to be understood that within the scope of the appended claims, the invention may be practiced otherwise than as specifically described herein.

1. A method for distributing rebate forms, the method comprising steps of:
detecting an identification code of a product at a point-of-sale;
accessing, based upon said identification code, rebate information for one or more rebate programs;
determining from the rebate information for one or more rebate programs whether said product has an associated rebate program; and
printing out the rebate form at the point-of-sale for the associated rebate program of said product;
wherein the rebate form serves as a proof-of-purchase for said product.

2. The method of claim 1, wherein said detecting step comprises:
scanning a universal product code of the product at the point-of-sale;
wherein the point-of-sale is a checkout stand.

3. The method of claim 2, wherein said accessing step comprises accessing a rebate information database.

4. The method of claim 2, wherein said accessing step comprises accessing encoded data from a label of said product.

5. The method of claim 1, wherein the rebate form comprises a rebate amount for said product.

6. The method of claim 1, wherein said product is a first product, and the rebate form comprises a total rebate amount for a plurality of products including said first product.

7. The method of claim 6, wherein said plurality of products is a predefined combination of products which is associated with a combination rebate offer.

8. The method of claim 6, wherein said plurality of products comprise a predefined number of the same product being purchased at the same time.

9. The method of claim 6, wherein said plurality of products comprise a predefined number of the same product being purchased within a given period of time.

10. The method of claim 1, wherein said rebate form is a customer specific rebate form which comprises information about a customer purchasing the product, the information comprising an address of the customer.

11. The method of claim 10, wherein said information about the customer is retrieved from a customer information database.

12. The method of claim 1, wherein said rebate form is a generic rebate form which comprises blank spaces to accommodate a mailing address of a customer.

13. The method of claim 1, wherein said rebate form comprises a mailing address of a clearing agent.

14. The method of claim 13, wherein the clearing agent is a manufacturer of said product.

15. The method of claim 13, further comprising a step of:
machine reading data from said rebate form by the clearing agent.

16. An apparatus for distributing rebate forms at a checkout stand, the apparatus comprising steps of:
a scanner at the checkout stand for detecting an identification code of a product;
a rebate information database in communication with the checkout stand, said rebate information database containing information of an associated rebate program for the product; and
a printer at the checkout stand for printing out the rebate form for the associated rebate program of said product;
wherein the rebate form serves as a proof-of-purchase for said product.

17. A method of providing rebate forms at a point-of-sale of a product, the method comprising steps of:
establishing a communication link between an information system of a retail store and a rebate clearinghouse;
storing information about a rebate program for said product in a database of said retail store;
configuring an information system of said retail store to print the rebate forms for said rebate program;
printing the rebate form at a point-of-sale within said retail store in response to a purchase transaction of the product, the printing of said rebate form being based upon information provided by the information system;
wherein information of the purchase of said product is communicated via the communications link from the retail store to the clearinghouse.

18. A method for providing a rebate to a customer, the method comprising steps of:
determining, at a point-of-sale, rebate information for a product having an associated rebate program;
printing out a rebate form at the point-of-sale for the associated rebate program of said product;
receiving, at a clearinghouse, the rebate form from said customer;
machine reading data from said rebate form by the clearinghouse; and
providing the rebate to the customer based upon results of the machine reading data step.

19. The method for providing a rebate to a customer of claim 18, wherein the rebate form serves as a proof-of-purchase for said product.

20. The method for providing a rebate to a customer of claim 18, further comprising a step of:
receiving, from a store associated with the point-of-sale, a verification code confirming a sale of said product.

21. A method for distributing rebate forms, the method comprising steps of:
detecting an identification code of a product at a point-of-sale;
accessing, based upon said identification code, rebate information for one or more rebate programs;
determining from the rebate information for one or more rebate programs whether said product has an associated rebate program; and
making the rebate form electronically available to a consumer computer;
wherein the rebate form serves as a proof-of-purchase for said product.

22. The method of claim 21 wherein the rebate form is emailed to said consumer computer.

23. The method of claim 21 wherein the rebate form is emailed to an email address associated with the identification code after a period of time after said step of determining.

24. The method of claim 23 wherein said period of time is between one day and one month.

25. The method of claim 21 wherein said rebate form is made available to the consumer on a personal web page.

26. The method of claim 25 wherein the rebate form is made available on said personal web page between one day and one month after said step of determining.
